(19) United States
(12) Patent Application Publication
(10) Pub. No.: US 2012/0325323 A1
(43) Pub. Date: Dec. 27, 2012

(54) PRODUCTION SYSTEM AND METHOD OF VARYING RESTRICTIONS TO FLOW ALONG THE SAME

(75) Inventors: Bennett M. Richard, Kingwood, TX (US); Michael H. Johnson, Katy, TX (US); Justin P. Vinson, Houston, TX (US)

(73) Assignee: BAKER HUGHES INCORPORATED, Houston, TX (US)

(21) Appl. No.: 13/167,456

(22) Filed: Jun. 23, 2011

(51) Int. Cl. F15D 1/00; F16L 55/00

(52) U.S. Cl. 137/1; 138/40

(57) ABSTRACT

A production system includes, a tubular having a plurality of sets of ports therethrough spaced longitudinally therealong positionable within a structure, at least one screen radial of the tubular defining an annulus between the structure and the at least one screen, at least one solids control mechanism configured to fill the annulus, and a plurality of flow restrictors. At least one of the flow restrictors is in operable communication with each of the plurality of sets of ports and is configured to generate different restrictions to a same flow rate through each of the plurality of sets of ports

### BACKGROUND

Tubular flow restrictors have been successfully employed to generate restrictions to flow for years. Torturous path flow restrictors employ passageways through helical or labyrinth shaped channels, for example, to generate restrictions to flow. Although such restrictors serve the function intended, the restriction is defined by channel geometry and as such is not adjustable once constructed. Operators are always receptive to new devices and methods to provide increased adjustability and control of the restriction generated in response to a particular flow rate.

### BRIEF DESCRIPTION

Disclosed herein is a production system. The system includes, a tubular having a plurality of sets of ports therethrough spaced longitudinally therealong positionable within a structure, at least one screen radial of the tubular defining an annulus between the structure and the at least one screen, at least one solids control mechanism configured to fill the annulus, and a plurality of flow restrictors. At least one of the flow restrictors is in operable communication with each of the plurality of sets of ports and is configured to generate different restrictions to a same flow rate through each of the plurality of sets of ports.

Further disclosed herein is a method of varying restrictions to flow along a production system. The method includes, filling an annulus defined between a structure and a screened tubular with at least one solids control mechanism, flowing substantially a same flow through the at least one solids control mechanism and through each of a plurality of sets of ports, wherein each set of ports is longitudinally distributed along a tubular from each other of the plurality of sets of ports, and adjusting one or more flow restrictors in operable communication with each of the plurality of sets of ports to generate a selected restriction level therewith in response to a selected flow therethrough.

### BRIEF DESCRIPTION OF THE DRAWINGS

The following descriptions should not be considered limiting in any way. With reference to the accompanying drawings, like elements are numbered alike:

FIG. 1 depicts a perspective view of a portion of production system disclosed herein;

FIG. 2 depicts a cross sectional view of a portion of the production system of FIG. 1;

FIG. 3 depicts a partially sectioned perspective view of the production system of FIG. 1;

FIG. 4 depicts a cross sectional view of the production system of FIG. 1 taken at arrows 4-4 with the flow restrictors in nonrestrictive positions;

FIG. 5 depicts a cross sectional view of the production system of FIG. 1 taken at arrows 4-4 with the flow restrictors in restrictive positions;

FIG. 6 depicts a perspective view of a portion of an alternate production system disclosed herein;

FIG. 7 depicts a cross sectional view of a portion of the production system of FIG. 6;

FIG. 8 depicts a partially sectioned perspective view of the and production system of FIG. 6; and

FIG. 9 depicts a cross sectional view of the production system of FIG. 6 taken at arrows 9-9 with the flow restrictors in nonrestrictive positions.

### DETAILED DESCRIPTION

A detailed description of one or more embodiments of the disclosed apparatus and method are presented herein by way of exemplification and not limitation with reference to the Figures.

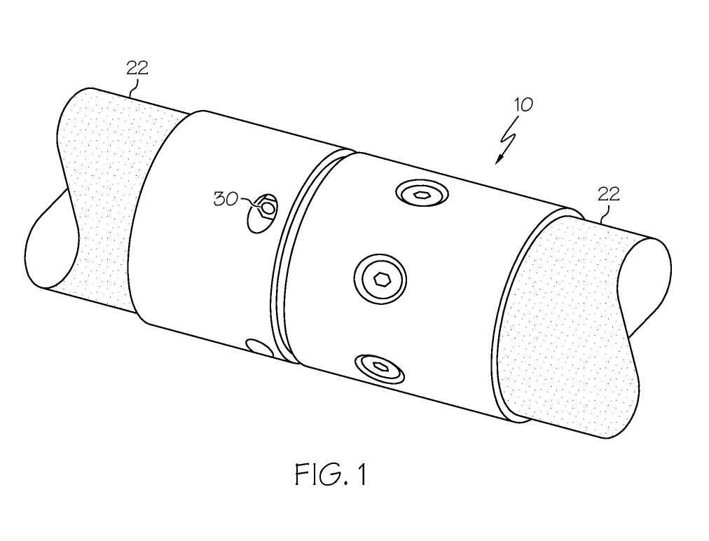

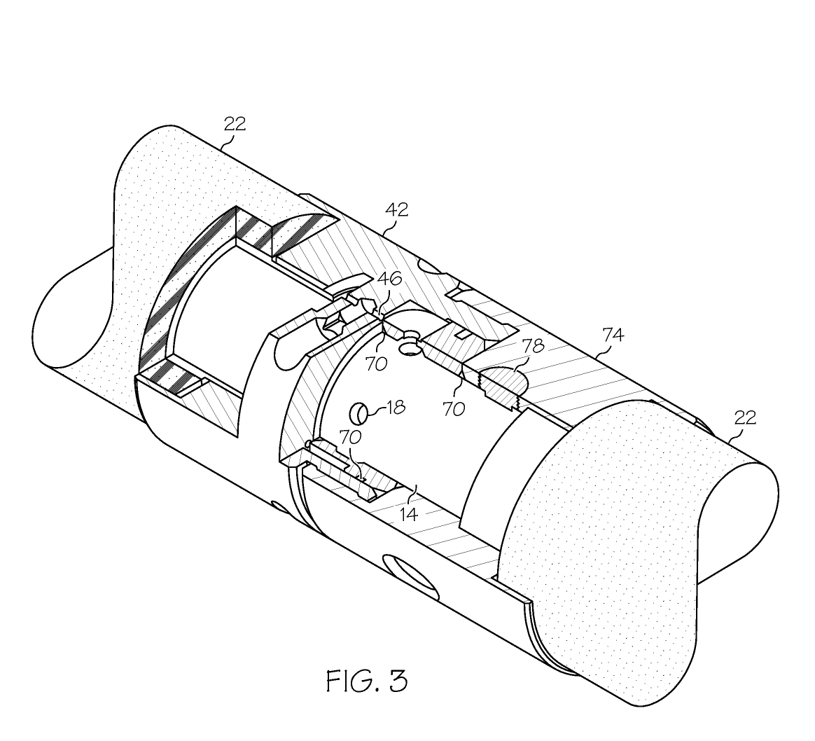

Referring to FIGS. 1, 2 and 3, a portion of a production system disclosed herein is illustrated at 10. The system 10 includes, a tubular 14 having a plurality of sets of ports 18, at least one solids control mechanism 22, a plurality of screens 26 and a plurality of flow restrictors 30. The foregoing are distributed longitudinally along the tubular 14 in sets such that each set includes at least one of the sets of ports 18, the solids control mechanisms 22, the screens 26 and the flow restrictors 30. FIGS. 1, 2 and 3 each show a portion of a single set. Although fluid can flow through each set in either direction, an example of flow through the set in the Figures is described herein as flowing radially inwardly through the solids control mechanism(s) 22. After flowing through the solids control mechanism(s) 22 the fluid flows radially inwardly through the screens 26, longitudinally in an annular space 34 defined between the screens 26 and the tubular 14, longitudinally through the flow restrictor(s) 30 and then radially through the set of ports 18 as indicated by the dashed line arrow 38. The flow restrictor(s) 30 of each set along the longitudinal length of the tubular 14 can be adjusted independently to create a selected restriction to a same flow through each set. Doing so allows an operator to establish a greater restriction at a position along the tubular that is, in this embodiment for example, further downstream than at a position further upstream to balance, or equalize, flow through each set with the flow through the other sets.

The solids control mechanism(s) 22 in this embodiment is expandable such that once it is placed within a structure 40, illustrated herein as a wellbore in an earth formation 41, it can expand to make contact with walls 44 of the wellbore 40 thereby filling an annulus defined between the screen 26 and the walls 44. The solids control mechanism(s) 22 may be a gravel pack, a permeable polymer that solidifies after filling the annulus, or foam, such as foam made of a shape memory material, for example, that upon increases in temperature expands to a larger volume. In an embodiment employing foam, contact with the walls 44 prior to the foam reaching its maximum expanded volume can result in the foam applying pressure to the walls 44. Such pressure eliminates any annular fluid passageway between the foam and the walls 44 that, if present, could allow fluid to flow longitudinally therethrough causing erosion and damage to the walls 44 in the process.

Although the embodiment illustrated shows the screen 26 as being a perforated sleeve, alternate embodiment are contemplated wherein the screen 26 is any structurally supportive member that allows fluid flow therethrough. Wire mesh that has wire wound into a tubular shape while leaving clearance between individual wire strands, for example, could be employed as the screen 26

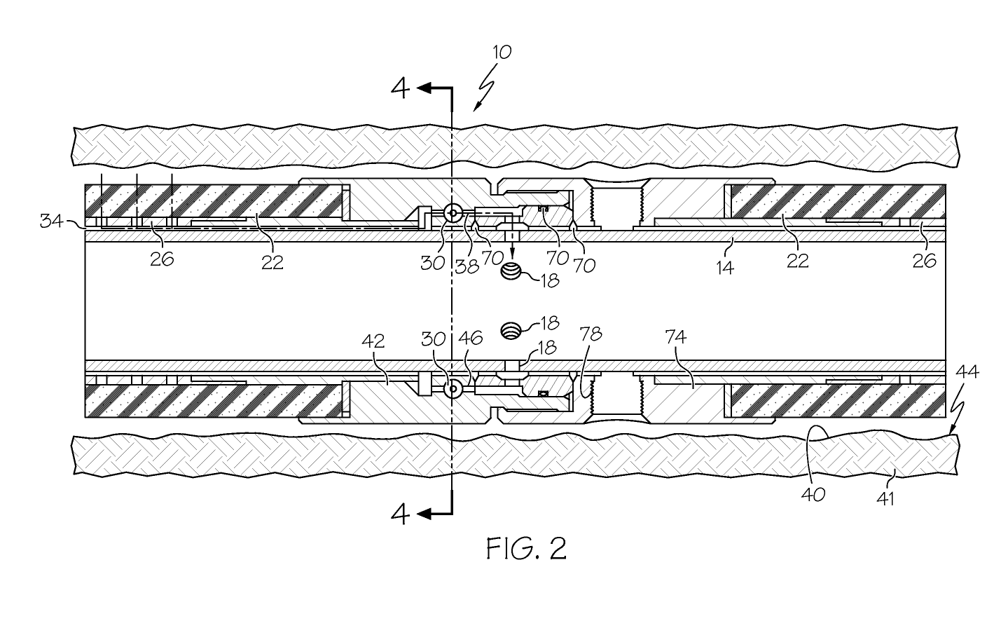

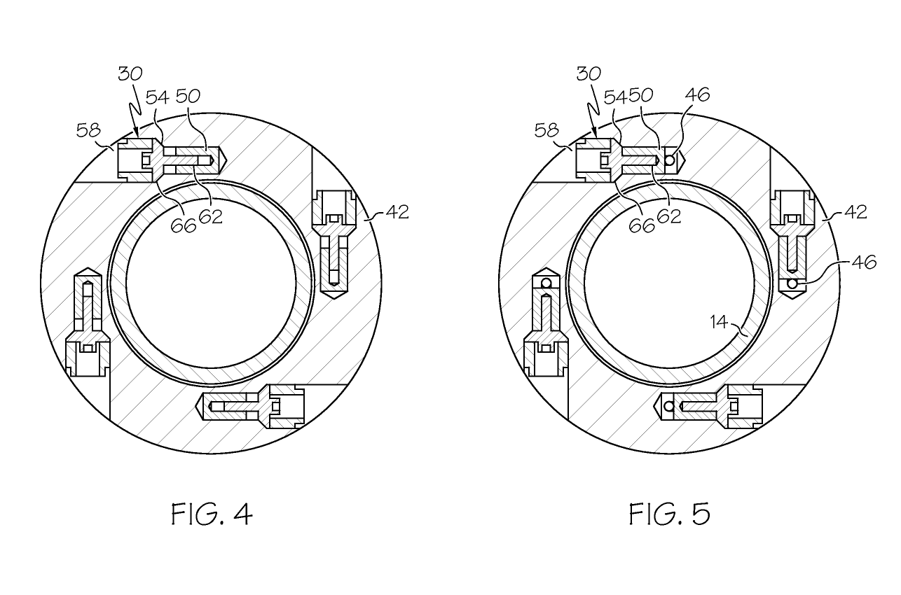

Referring to FIGS. 4 and 5, each set of the embodiment illustrated also includes a collar 42 with longitudinal bores 46 (also visible in FIG. 2). The flow restrictors 30 interface with the bores 42 to restrict flow therethrough. Specifically, in this embodiment, a traveler 50 is threadably engaged with a threaded locator 54 that is maintained positionally in the collar 42 by a plug 58. Rotation of the threaded locator 54 causes the traveler 50 to move along the threads 62 of the threaded locator 54 within the collar 42. The traveler 50 intersects with the bore 46 such that it fully occludes the bore 46 when the traveler 50 is positioned furthest from a head 66 of the threaded locator 54 and does not occlude the bore 46 at all when the traveler 50 is at a position closest to the head 66. Positioning the traveler 50 at positions between these two extremes can cause a variable amount of restriction to flow through the bore 46. Although this embodiment has four flow restrictors 30, any practical number that can fit within the collar 42 are contemplated.

It should be noted that although multiple solids control mechanisms 22 are illustrated in the embodiment herein as being individual pieces separated from one another by the collar 42 (among other things), a longitudinally continuous solids control mechanism 22 that perimetrically surrounds the collar (not shown) is also contemplated.

Referring again to FIG. 2, a seal 70 sealingly engages the collar 42 to the tubular 14 thereby preventing fluid from flow therebetween, consequently the fluid is forced to flow through the bores 46 and the flow restrictors 30 before it can flow through the set of ports 18. Additional seals 70 prevent fluid from flowing anywhere other than through the set of ports 18. Spacers 74, positioned between adjacent sets, are fixedly positioned along the tubular 14 with threaded members 78 that frictionally engage with the tubular 14.

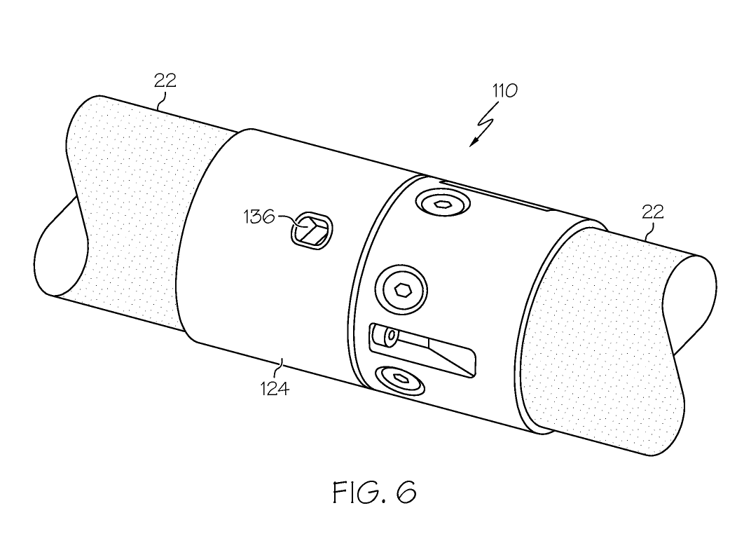

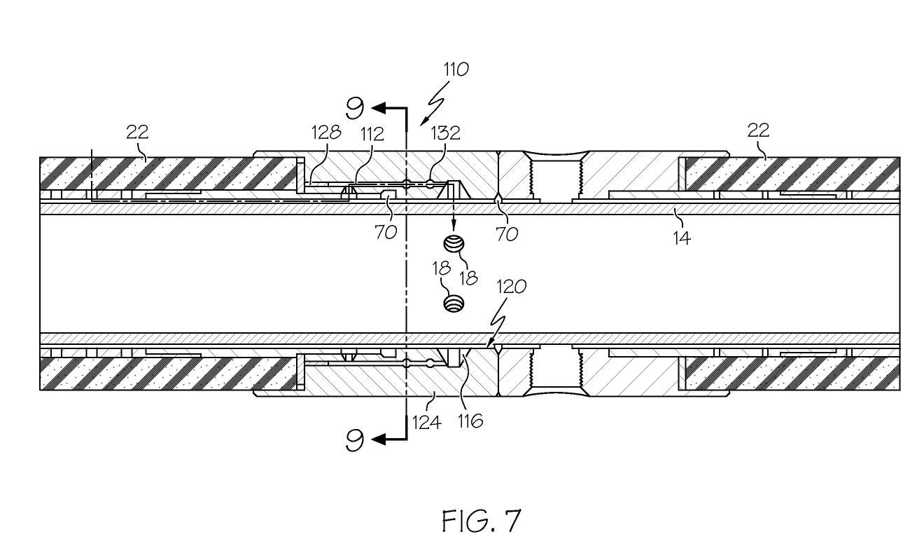

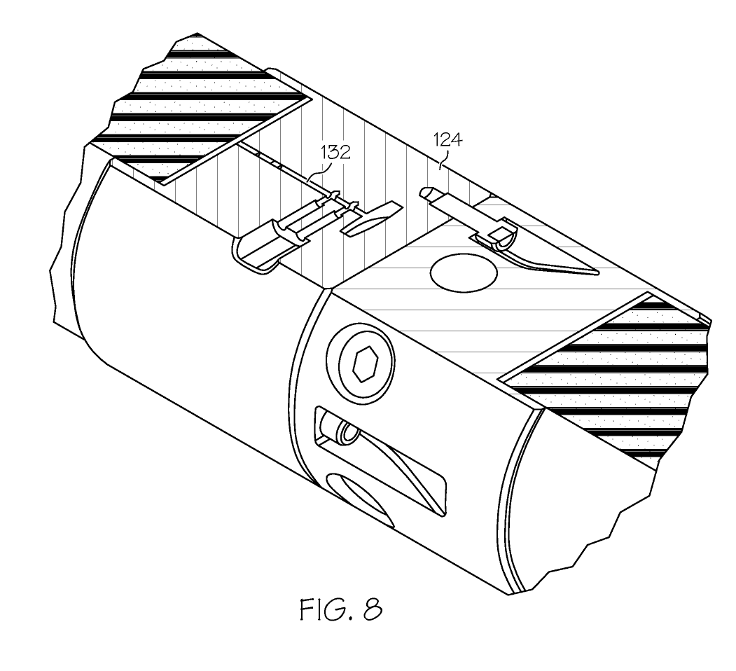

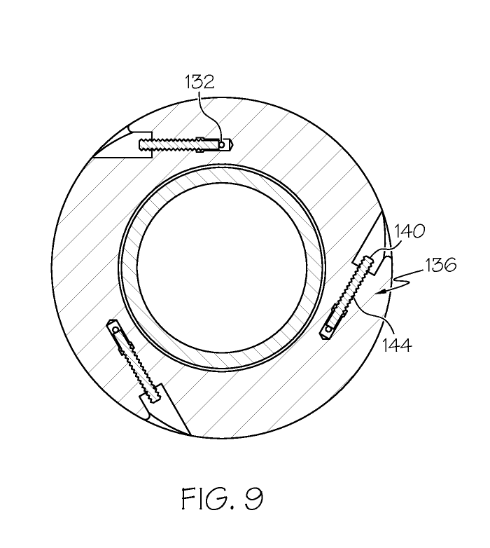

FIGS. 6-9 are similar views to FIGS. 1-4 illustrating an alternate embodiment of a production system 110 disclosed herein. Like elements in this embodiment are identified with the same reference characters used above to describe the production system 10. As such, only differences between the two embodiments will be described in detail hereunder. The device 110 primarily differs from the device 10 in the flow path between the annular space 34 and the set of ports 18, which is depicted by dashed line arrow 112. An internal recess 116 in the inner radial surface 120 of the collar 124 allows for one less seal 70 to be employed in comparison to the device 10. However, plugs 128 are used to block a portion of the bores 132 that would otherwise allow fluid to flow back out through the solids control mechanism(s) 22.

Additionally, the device 110 employs three flow restrictors 136 instead of four as used in the device 10. Each of the flow restrictors 136 employs two travelers 140 that interact with the bores 132 to restrict flow therethrough. The travelers 140 are similar to set screws that threadably engage directly into threaded holes 144 in the collar 124.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A production system comprising:
a tubular having a plurality of sets of ports therethrough spaced longitudinally therealong positionable within a structure;
at least one screen radial of the tubular defining an annulus between the structure and the at least one screen;
at least one solids control mechanism configured to fill the annulus; and
a plurality of flow restrictors with at least one flow restrictor being in operable communication with each of the plurality of sets of ports and being configured to generate different restrictions to a same flow rate through each of the plurality of sets of ports.

2. The production system of claim 1, wherein the at least one solids control mechanism is expandable foam.

3. The production system of claim 1, further comprising a collar receptive to at least one of the plurality of flow restrictors.

4. The production system of claim 3, wherein the at least one of the plurality of flow restrictors restricts flow through a bore extending longitudinally through a portion of the collar.

5. The production system of claim 3, wherein the collar is sealed to the tubular.

6. The production system of claim 1, wherein the at least one solids control mechanism is a plurality of solids control mechanisms, and the plurality of solids control mechanisms the plurality of flow restrictors and the plurality of sets of ports are grouped in sets so that flow through one of the solids control mechanisms of a particular set also must flow through the flow restrictors and the set of ports of that particular set.

7. The production system of claim 6, wherein a plurality of the sets are distributed longitudinally along the tubular.

8. The production system of claim 6, wherein the flow restrictors of each set are independently adjustable to generate different restrictions to the same flow rates through the set of ports of each set.

9. The production system of claim 1, wherein the different restrictions are selected based on anticipated longitudinal positions of the plurality of sets of ports along the tubular.

10. The production system of claim 1, wherein at least one of the plurality of sets of ports includes a single port.

11. A method of varying restrictions to flow along a production system, comprising:
filling an annulus defined between a structure and a screened tubular with at least one solids control mechanism;
flowing substantially a same flow through the at least one solids control mechanism and through each of a plurality of sets of ports, each set of ports being longitudinally distributed along a tubular from each other of the plurality of sets of ports; and
adjusting one or more flow restrictors in operable communication with each of the plurality of sets of ports to generate a selected restriction level therewith in response to a selected flow therethrough.

12. The method of varying restrictions to flow along the production system of claim 11, further comprising flowing the same flow rate through one or more of the plurality of sets of ports through the tubular in operable communication with each of the at least one solids control mechanisms.

13. The method of varying restrictions to flow along the production system of claim 11, further comprising flowing the same flow rate through an annular flow passageway defined between a screen and the tubular.

14. The method of varying restrictions to flow along the production system of claim 11, further comprising selecting the selected restriction level based on position of each of the plurality of sets of ports, along the tubular.
